(19) United States
(12) Patent Application Publication
(10) Pub. No.: US 2007/0140271 A1
(43) Pub. Date: Jun. 21, 2007

(54) Method and system for terminating SONET/SDH circuits in an IP network

(76) Inventors: Shane M. Amante, Denver, CO (US); Donald J. Fendrick, Broomfield, CO (US)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(21) Appl. No.: 11/314,103

(22) Filed: Dec. 21, 2005

(51) Int. Cl. H04L 12/56

(52) U.S. Cl. 370/401

(57) ABSTRACT

A method and system for terminating SONET/SDH circuits in an IP network includes a SONET/SDH to Ethernet inter-working device/functionality implemented in a network element for mapping SONET/SDH channels into logical channels over an Ethernet connection. The SONET/SDH channels are de-encapsulated to remove Layer-2 protocols and expose IP packets. The IP packets are encapsulated with Ethernet headers and logical tags for transmission over the Ethernet connection to their final destinations via a Provider Edge (IP) router.

### TECHNICAL FIELD

This invention relates generally to IP networks, and more particularly, to a system and method for terminating SONET or SDH channels, then translating and bridging the respective SONET or SDH channels to deliver IP packets contained therein onto an Ethernet network.

### BACKGROUND ART

Presently, SONET/SDH (collectively referring to SONET and/or SDH) is the predominant Layer-1 (physical layer) technology used to facilitate delivery of high speed customer access circuits into a service provider's IP network. Because of its nearly ubiquitous worldwide deployment, it is believed that SONET/SDH will continue to be the Wide Area Network (WAN) transport medium of choice for the foreseeable future. However, there are substantial inefficiencies in delivery of SONET/SDH circuits that terminate directly on IP routers.

By way of background, those skilled in the art will recognize that Synchronous Optical Network (SONET) and Synchronous Digital Hierarchy (SDH) are a set of related standards for synchronous data transmission over fiber optic networks. SONET is the United States version of the standard published by the American Standards Institute (ANSI). SDH is the international version of the standard published by the International Telecommunications Union (ITU). SONET and SDH were designed and implemented in the mid 1980's to alleviate problems associated with the delivery of traditional digital telecommunications services such as T1/DS1s in Time Division Multiplexed (TDM) architectures.

DS1s were designed to aggregate analog telephone lines for more efficient transport between central offices. Twenty four digitized voice lines (DS0s) may be carried over a DS1 using TDM. The DS (Digital Signal or Data Service) level refers to a classification originated by AT&T for transmitting one or more voice conversations in a digital data stream. The best known DS levels are DS0 (the zeroth level) having a transmission rate of 64,0000 bits per second (64 kb/s) intended to carry one voice channel, DS1(24 conversations multiplexed), DS1C, DS2 and DS3. By extension, the DS level can similarly refer to the raw data necessary for transmission: DS0-64 Kb/s, DS1-1.544 Mb/s, DS1C-3.15 Mb/s, DS2-6.31 Mb/s, DS3-44.736 Mb/s, etc. In this sense, the DS level can thus be used to measure data service rates classifying the user access rates for various point-to-point WAN technologies or standards.

In the above TDM architecture, multiple channels (in the case of DS1—24 channels) share the circuit in rotation, with each DS0 having its own assigned time slot to use as necessary. Because each channel is always found in the same place, no address is needed to demultiplex a given channel at its destination. Twenty eight DS1s are TDM aggregated into a DS3 in this manner. As discussed further below, this is in sharp contrast to packet-based networks such as Ethernet where there are no assigned time slots. Instead, packets are multiplexed onto media via an arbitration mechanism and demultiplexed via MAC addresses.

The above DS1/DS3 system is asynchronous (not synchronous), or at best “plesiosynchronous” (almost synchronous) as each terminal in the network runs on its own free-running clock not synchronized to any other clock in the network. Large variations may therefore occur in the respective clock rates and signal bit rates resulting in transitions of signals at different nominal rates. This is in sharp contrast to SONET/SDH networks which are precisely synchronous as all clocks are traceable to a single primary reference clock.

As more and more channels are multiplexed together in the above TDM architecture, significant timing problems therefore arise. For example, since the timing on various DS1s going into a given DS3 may differ slightly, padding of some channels (bit stuffing) is required to align all within the DS3 frame. Once this is done, the individual DS1s are no longer accessible unless the DS3 is completely demultiplexed. Thus, in order to access an individual DS1 channel, the whole DS3 frame must be torn down and then rebuilt. The equipment required to perform this task is complex and expensive to purchase, implement and maintain. Additional problems occur where different networks with relatively wide differences in timing meet, such as Europe and the United States. Again, the equipment necessary to account for these differences is both complex and expensive.

As indicated above, SONET/SDH are standards for optical telecommunications transport that were specifically designed and implemented to overcome the above referenced problems associated with traditional digital telecommunications in general, and TDM architectures in particular. SONET defines a technology for carrying many signals of different capacities through a synchronous, flexible, optical hierarchy by means of a byte-interleaved multiplexing scheme. As those skilled in the art are aware, the first step in the SONET multiplexing process involves the generation of the lowest or base signal. This base signal is referred to as the synchronous transport signal—level 1, or simply STS-1, which operates at 51.84 Mbps. Higher-level signals are integer multiples of STS-1. Each STS-N signal further has an Optical Carrier level n (OC-n) counterpart. For example, in the SONET hierarchy, STS-1/OC-1 has a bit rate of 51.84 Mbps and a capacity of 28 DS-1s or 1 DS-3. Similarly, STS-3/OC-3 has a bit rate of 155.520 and a capacity of 84 DS-1s or 3 DS-3s. Still further, STS-12/OC-12 has a bit rate of 622.08 Mbps and a capacity of 336 DS-1s or 12 DS-3s.

The STS-1 frame referenced above is the basic building block of the SONET protocol. The frame format of the STS-1 signal is illustrated in FIG. 1 and referred to generally by reference numeral 2. In general, the frame can be divided into two main areas, namely, transport overhead 4 and the synchronous payload envelope (SPE) 6. The SPE 6 can further be divided into the STS path overhead (POH) and the payload. As those skilled in the art are aware, the payload is the revenue-producing traffic being transported and routed over the SONET network. Once the payload is multiplexed into the SPE 6, it can be transported and switched through SONET without having to be examined and possibly de-multiplexed at intermediate nodes. Thus, SONET is characterized as being service-independent or “transparent”. Transport overhead is comprised of section overhead and line overhead. The STS-1 POH is part of the synchronous payload envelope. The STS-1 payload has the capacity to transport up to 28 DS-1s; 1 DS-3; 212.048 Mbps signals; or combinations of each. SDH has a similar methodology to SONET. With the exception of a couple of bits, SONET and SDH are equivalent for synchronous payloads of 155.52 Mbps.

In addition to the above STS-1 base format, SONET further defines synchronous formats at sub-STS-1 levels. Accordingly, the STS-1 payload may be subdivided into virtual tributaries. Virtual tributary information is organized inside an STS-1 channel of SONET frames and routed through the network to a specified destination from a given source location.

There are four types or “sizes” of virtual tributaries, namely VT1.5, VT2, VT3 and VT6. A VT1.5 has the lowest payload capacity with a data rate of 2.304 Mbps. A VT2 has a data rate of 2.304 Mbps. Still further, a VT3 operates at 3.456 Mbps. Finally, a VT6 has a data rate of 6.912 Mbps. The different size tributaries are provided to maximize available bandwidth in an STS-1 channel. For example, if the end user requires the transport of DS-1C signals requiring 3.152 Mbps, a virtual tributary VT3 size offers the best solution as opposed to a VT6 that provides substantially greater bandwidth than what is needed. Common low rate signals such as DS-1, E1 and DS-2 fit into virtual tributary sizes VT1.5, VT2 and VT6, respectively.

Accordingly, the SONET base signal STS-1/OC-1 (51.85 Mbps) has a capacity of 28 DS-1/VT1.5s or 1 DS-3. Similarly, STS-3/OC-3 (155.520 Mbps) has a capacity of 84DS-1/VT1.5s or 3 DS-3s, and STS-12/OC-12 (622.08 Mbps) has a capacity of 336DS-1/VT1.5s or 12 DS-3s. Further, the STS-1 payload discussed above has the capacity to transport up to 28 DS-1/V1.5s.

By way of further overview, the OSI, or Open System Interconnection model referenced herein is understood to define a networking framework for implementing protocols in seven (7) logical layers. The lower layers deal with electrical signals, chunks of binary data, and routing of data across networks. Higher levels cover network requests and responses, representation of data, and network protocols as seen from a users point of view. These layers, from top to bottom, are as follows: Application (Layer-7), Presentation/Syntax (Layer-6), Session (Layer-5), Transport (Layer-4), Network (Layer-3), Data Link (Layer-2) and Physical (Layer-1). In operation, control is passed from one layer to the next, starting at the Application layer in one station, proceeding to the bottom layer, over the channel to the next station and back up the hierarchy.

The Application layer (Layer-7) is the highest layer in the OSI model and provides user application access to the communication facilities provided by the lower six layers for exchanging data between applications that can be running on different machines. The Presentation layer (Layer-6) handles any data representation, translation, and presentation duties for communicating applications. Similarly, the Session layer (Layer-5) establishes and maintains the connection between different processes that are running on different machines. It handles connection establishment and data transfer between the sessions. The Transport layer (Layer-4) ties together the process-to-process communication of the upper three user levels. It guarantees error-free, end-to-end data transfer between communicating device.

Layers 1-3 are of particular relevance to the present invention. The Network layer (Layer-3) provides switching and routing technologies, creating logical paths known as virtual circuits, for transmitting data from node to node. Routing and forwarding are functions of this layer, as well as addressing, internetworking, error handling, congestion control and packet sequencing. The Data Link Layer (Layer-2) provides error-free transmission for the network layer above. This layer furnishes transmission protocol knowledge and management and handles errors in the physical layer, flow control and frame synchronization. In operation, data packets are encoded and decoded into bits in this layer. The Data Link layer is further divided into two sublayers, namely the Media Access Control (MAC) layer and the Logical Link Control (LLC) layer. The MAC sublayer controls how a computer of the network gains access to the data and permission to transmit it. The LLC sublayer controls frame synchronization, flow control and error checking. The Physical layer (Layer-1) is the lowest level in the OSI model. This layer handles the interface to the physical medium and deals with the various physical characteristics of the medium such as voltages, data rates, and so on. Physical layers include optical and wireless technologies. In operation, the Physical layer functions to convey bit streams through the network at the electrical and mechanical level. It provides the hardware means of sending and receiving data on a carrier, including defining cables, cards and physical aspects.

As indicated above, there are substantial inefficiencies in conventional networks wherein SONET/SDH circuits terminate directly on IP routers. In particular, such systems require the purchase of duplicate SONET/SDH ports to deliver a SONET circuit to an IP router. Such a network is illustrated in FIG. 2 and referred to generally by reference numeral 10. As shown, in network 10, a Customer Edge (CE) IP router 12 attaches directly to a SONET/SDH access circuit 14 at an appropriate speed. A CE IP router is a device owned and operated by a single Customer, for the purpose of attaching to a Service Provider's IP network such as, for example, the Level 3 Communications, Inc. IP backbone. A CE nearly always has one, or more, directly attached WAN interfaces that connect to a Service Provider using Point-To-Point (PPP) over SONET/SDH or Cisco High Level Data Link Control (HDLC) protocol over SONET/SDH encapsulation. In addition, a CE may have one, or more, directly attached Local Area Network (LAN) interfaces that connect to other devices on the Customer Premises via native Ethernet (802.1q) encapsulation.

As those skilled in the art are aware, the HDLC protocol is defined generally by the International Standards Organization (ISO) with further variation by Cisco. Relative to the OSI model above, HDLC provides a transparent transmission service at the Data Link layer (Layer-2). Many protocol suites use an HDLC (or HDLC-based) link layer, including PPP. The users of the HDLC service provide Protocol Data Units (PDUs) which are encapsulated to form data link layer frames. These frames are separated by HDLC “flags” and are modified by “zero bit insertion” to guarantee transparency.

PPP is a protocol for communication between computers which uses a serial interface. PPP uses the Internet Protocol (IP) and is designed to handle others. It is sometimes considered a member of the TCP/IP suite of protocols. PPP provides Layer-2 (Data Link) service. Essentially, it packages TCP/IP packets and forwards them to a server where they can actually be put on the Internet. PPP is a full-duplex protocol that can be used on various physical media, including twisted pair or fiber optic lines. It uses a variation of HDLC for packet encapsulation and can handle both synchronous and asynchronous communication.

Still referring to FIG. 2, CE 12 thus functions to encapsulate IP packets into PPP or Cisco HDLC, Layer-2 encapsulation over its directly attached SONET/SDH access circuit 14. SONET frames are then carried through an access network (in most cases not owned or operated by the Service Provider) where they are ultimately delivered to the Service Provider's SONET Transport network 18. The SONET circuit may be back-hauled a significant distance on the Service Provider SONET Transport network 18 for delivery to a Gateway 20 where there are IP/MPLS-capable Provider Edge (PE) IP Routers 22 that can terminate the SONET circuit and provide the requisite IP or MPLS service. A PE IP router such as router 22 is a router between one network service provider's area and areas administered by other network providers. It is typically owned and operated by a Service Provider and refers generally to equipment capable of a broad range of routing protocols, notably Border Gateway Protocol (BGP), Open Shortest Path First (OSPF) and Multi-Protocol Label Switching (MPLS). While some routers may perform a labeling function, they generally do not need to be aware of what kind of traffic is coming from the provider's network. The specific purpose of PE IP router 22 in the described legacy system is to aggregate multiple (WAN or LAN) “circuits” that attach to several dozen or several hundreds of CE's 12. As shown, PE IP routers 22 are provided in communication with the Service Provider's IP/MPLS network 24.

MPLS technologies are a set of procedures for combining the Layer-2 label swapping paradigm with Layer-3 routing functionality. The basic premise of MPLS is that by assigning short, fixed-length labels to packets and then using only these pre-assigned labels for forwarding, certain efficiencies and additional, desirable network behaviors can be achieved. Accordingly, in an MPLS network such as network 24, incoming packets are assigned a “label” by a “Label Edge Router (LER)”. Packets are then forwarded along a “Label Switch Path (LSP)” where each “Label Switch Router (LSR)” makes forwarding decisions based solely on the contents of the label. At each hop, the LSR strips off the existing label and applies a new label which tells the next hop how to forward the packet. LSPs are established by the network operators for a variety of purposes, such as to guarantee a certain level of performance, to route around network congestion, or to create IP tunnels for network-based virtual private networks. LSPs function similar to circuit-switched paths in Asynchronous Transfer Mode (ATM) or Frame Relay networks, but without dependence on a particular Layer-2 technology. LSPs can also be established to cross multiple Layer-2 transports.

Referring still to FIG. 2, within the IP/MPLS Gateway 20, a SONET/SDH Add/Drop Multiplexer (ADM)/Digital Cross Connect (DCS) 26 is directly attached to the PE IP router 22, typically via non-concatenated OC-12 or OC-48. The PE router 22 and SONET ADM/DCS 26 are, accordingly, responsible for facilitating access to the OC-3c, OC-12c or, possibly, OC-48c channels contained within the SONET/SDH interconnection between them. For reference purposes, it is understood that the OC-3c channel is an OC-3 optical carrier containing an STS-3c payload. Similarly, an OC-12c channel is an OC-12 optical carrier containing an STS-12 payload, etc. Significantly, the SONET/SDH ADM/DCS 26 is completely unaware of the Layer-2, or above encapsulations (i.e. PPP/HDLC) used on any of the OC-n circuits. In operation, the PE IP router 22 de-encapsulates the SONET Payload Envelope to expose either PPP or Cisco-HDLC frames. It further de-encapsulates the Layer-2 frames to expose IP packets. At this point, PE router 22 makes a Layer-3 IP routing decision allowing it to forward the packet to its destination through the Service Provider's IP/MPLS backbone 24.

There is nearly always only a single /30 IP subnet between the PE IP router 22 and CE router 12 because there is only a “physical” point-to-point circuit connecting the two IP devices. An IP subnet is a contiguous set of IP addresses that allow a collection of IP devices (hosts, routers and/or switches) to communicate with one another across a physical and/or logical medium. This legacy architecture discussed in detail above is subject to substantial inefficiencies. For example, it requires the purchase of duplicate SONET/SDH ports just to deliver SONET circuits to an IP router. One SONET/SDH port is required on the ADM/DCS 26 and a second SONET/SDH linecard is required on the PE IP router 22.

Consequently, a need has developed for an improved architecture for terminating SONET/SDH circuits to more efficiently deliver IP packets to a Service Provider's IP/MPLS network. Such an architecture should support existing Layer-2 protocols built into dominant IP/MPLS routers and should be implemented transparently and seamlessly to customers to obviate the need and expense of additional Customer Premise (CP) stand alone equipment.

Significantly, the desired architecture is not an Ethernet over SONET solution. As those skilled in the art are aware, the overwhelming majority of legacy IP/MPLS routers and switches do not support Generic Framing Procedure (GFP) or X.86, nor are they likely to do so in the near future. Therefore, an Ethernet over SONET solution is unacceptable as it would require the customer (or Service Provider) to invest in dedicated, standalone CE-based SONET-to-Ethernet media conversion devices in addition to the purchase of Ethernet line cards for Customer Edge IP routers 12. Further, the architecture should not add complex IP/MPLS routing functionality into existing network elements, specifically the SONET/SDH ADM or DCS 26. The addition of such routing and signaling protocols would similarly add unnecessary and undesirable cost, complexity and time to emulate the rich functionality which already exists in conventional CE IP routers 12 and PE routers 22.

Finally, such an architecture should fully utilize SONET/SDH as the Physical layer (Layer-1 protocol). While other solutions such as, for example, MetroEthernet may improve the cost of delivering access circuits, none are as ubiquitous as SONET/SDH. Accordingly, the desired architecture must seamlessly interoperate in the existing network where SONET/SDH plays a significant role in delivering tail circuits to customers.

### DISCLOSURE OF INVENTION

It is a principle object of the present invention to provide an improved method and system for terminating SONET/SDH circuits in an IP network to deliver IP packets.

It is a further object of the present invention to provide a SONET/SDH to Ethernet inter-working device and/or functionality that may be implemented in a conventional IP network to function as a Layer-2 translation bridge to receive, translate (between disparate Layer-2 media) and, subsequently bridge IP packets between SONET/SDH based access circuits onto Ethernet (IEEE 802.3) media.

In carrying out these and other objects, features and advantages of the present invention, there is provided a method for terminating SONET/SDH circuits in an IP network. The method comprises providing a Gateway having a network element for receiving the SONET/SDH circuits and an IP router for routing IP packets to their final destinations. The method further comprises providing an Ethernet interface between the network element and the IP router. The network element is responsible for translating the Layer-2 encapsulation, from SONET/SDH to Ethernet, and subsequently translating and bridging the IP packets received at the network element from the SONET/SDH access circuits onto the Ethernet interface. In a preferred embodiment, the step of translating and bridging the IP packets onto the Ethernet interface further comprises de-encapsulating SONET/SDH channels received at the network element to remove any Layer-2 protocol and to expose the IP packets. The SONET/SDH channels are thereafter mapped into logical channels over the Ethernet interface by encapsulating the IP packets with Ethernet headers and logical tags such as IEEE 802.1q VLAN tags.

In further carrying out the above objects, features and advantages of the present invention, there is similarly provided a system for terminating SONET/SDH circuits in an IP network to deliver IP packets. The system comprises a Gateway having a network element for receiving the SONET/SDH circuits and an IP router for routing the IP packets to their final destinations in the IP/MPLS network. The system further comprises an Ethernet interface in communication with the network element and the IP router. The network element is operative to receive, translate and bridge the SONET/SDH access circuits onto the Ethernet interface. In a preferred embodiment, the network element performs these functions by (a) de-encapsulating SONET/SDH channels received at the network element to remove any Layer-2 protocol and expose the IP packets; and (b) mapping the SONET/SDH channels into logical channels by encapsulating the IP packets with Ethernet headers and VLAN tags. Still further, in the preferred embodiment, the network element is an ADM and/or DCS.

The above objects, features, and advantages of the present invention are readily apparent from the following detailed description of the best modes for carrying out the invention when taken in conjunction with the accompanying drawings wherein like reference numerals correspond to like components.

### BRIEF DESCRIPTION OF DRAWINGS

FIG. 1 is a schematic diagram of the frame format of an STS-1 signal;

FIG. 2 is a schematic diagram of a legacy system for directly terminating SONET/SDH circuits in an IP network to deliver IP packets;

FIG. 3 is a schematic diagram of the system of the present invention for logically terminating SONET/SDH circuits in an IP network to deliver IP packets; and

FIG. 4 is a block diagram of the method steps of the present invention.

### BEST MODES FOR CARRYING OUT THE INVENTION

The system of the present invention is shown in FIG. 3 of the drawings and designated generally by reference numeral 30. As discussed above, the SONET/SDH to Ethernet Inter-working Device and functionality implemented in the system is intended to provide cost-efficient and “backwards-compatible” delivery of SONET/SDH access circuits to Service Provider IP routers, without having a directly attached SONET interconnection circuit between the Service Provider PE router and its SONET ADM or DCS. Thus, like the legacy solution of FIG. 1, the CE (IP) router 12 will still attach directly to and communicate with the SONET access circuit 14. CE router 12 is similarly still responsible for encapsulating its IP packets over PPP, Cisco-HDLC or other suitable Layer-2 protocol and transmitting the encapsulated IP packets directly onto an access network 16 which, as indicated above, is typically not owned or operated by the Service Provider.

This standard configuration at the CE IP router 12 specifically addresses the “backwards-compatibility” issue from the customer viewpoint in that it obviates the need for the customer to purchase and deploy any new Customer Premises Equipment (CPE) devices. For existing customers, it further permits the Service Provider to stage a seamless migration within the Service Provider Gateway 20, onto the service provided by the system with minimal, or no coordination with the customer.

Referring still to FIG. 3, the customer's SONET/SDH circuit is handed off to the Service Provider's Transport Network 18 where it is eventually delivered to an IP-capable Service Provider Gateway 20. In the preferred embodiment, the SONET to Ethernet Inter-working Device (SEID) and/or functionality 32 is deployed in this Gateway 20. More specifically, the device and/or functionality is preferably co-located inside of and integrated directly with a SONET/SDH ADM or DCS. However, it is understood that the SEID 32 may exist as a separate network element or comprise functionality which resides in one or more network elements including, but not limited to the above referenced SONET/SDH ADM/DCS 26.

In keeping with the invention, the inter-working device/functionality 32 has two sides: (1) an “Access Side” 34 which faces the SONET/SDH Transport Network 18; and (2) a “Line Side” (Linecard) 36 which faces the IP/MPLS network 24, and more particularly, an Ethernet interface 38. The Access Side 34 may be comprised of one or more OC-192n (OC-3, OC-12, OC-48, OC-192) trunks. On the Line Side 36, there is a minimum of one and preferably at least two 10 Gigabit Ethernet LAN PHY interfaces, each with pluggable XENPAK's. The Ethernet interfaces may be 1 Gigabit, 10 Gigabit, etc.

On the Access Side 34, the SONET/SDH to Ethernet inter-working device and/or functionality 32 is capable of supporting a minimum of STS-1 grooming. Virtual Concatenation (VCAT) and Link Capacity Adjustment Scheme (LCAS) are preferred, but not required. At a minimum, the device 32 functions to extract OC-3c/STM-1c, OC-12c/STM-4c and OC-48c/STM-16c channels since CE IP routers 12 only have SONET/SDH interfaces that operate at these speeds. The device and functionality 32 similarly have the ability to extract any combination of OC-n channels from within the OC-192 Line Side trunk.

On the Line Side 36, the SONET/SDH to Ethernet inter-working device and functionality 32 terminates the Layer-1 SONET and Layer-2 protocol (PPP, Cisco-HDLC, etc.) sessions from the CE (IP) router 12. In doing so, the Line Side 36 performs required processing of the Layer-2 WAN protocol, sequence numbers, checksums, etc. for frames received over the SONET/SDH circuit. In addition, the Line Side 36 may perform Address Resolution Protocol (ARP) mediation between the CE (IP) router 12 and the upstream Layer-3 PE IP router 22. As those skilled in the art are aware, ARP is the method for finding a host's MAC address when only its IP address is known. A sender broadcasts and ARP packet containing the IP address of another host and then waits for it to respond with its MAC address. ARP “mediation” is the process of resolving Layer 2 addresses when different resolution protocols are used on either circuit (here PPP and Ethernet) In short, the device and functionality 32 described herein de-encapsulates the SONET/SDH channels received at a network element (preferably, but not necessarily a ADM/DCS 26) to remove any and all Layer-2 protocols and expose the IP packets. The IP packets are subsequently encapsulated with Ethernet headers and suitable logical tags such as IEEE 802.1q VLAN tags so as to map the SONET/SDH channels into logical channels over the Ethernet interface 38.

Ethernet is a frame-based computer networking technology for LANs. Ethernet is based on the idea of peers on a network sending messages in what was essentially a radio system captive inside a common wire or channel, sometimes referred to as the “ether”. The term “ether” is derived from luminiferous aether—a medium through which 19^{th} century physicists incorrectly theorized that electromagnetic radiation traveled. Today, Ethernet defines wiring and signaling for the Physical layer (Layer-1) as well as frame formats and protocols for the MAC/Data Link layer (Layer-2). Each peer on an Ethernet has a globally unique 48-bit key known as the MAC address and discussed in further detail below. This address is factory-assigned to the network interface card to ensure that all systems in an Ethernet have distinct addresses.

There are many varieties of Ethernet based on framing types as well as variations in speed and wiring. These include, for example, 10 Mbit/s Ethernet, Fast Ethernet (100 Mbit/s), Gigabit Ethernet and 10 Gigabit Ethernet. Any suitable variety may be used in accordance with the present invention depending on the specific application and the desired result. In a preferred embodiment disclosed herein, however, 10 Gigabit Ethernet is utilized. The new 10 Gigabit Ethernet standard encompasses seven different media types for LAN, MAN and WAN. It is currently specified by supplementary standards including IEEE 802.3ae and will be incorporated into a future revision of the 802.3 standard.

A VLAN (short for Virtual LAN), is a network of computers that function as if they are connected to the same wire even though they may actually be physically located on different segments of a LAN. VLANs are configured through software rather than hardware, which makes them extremely flexible. As those skilled in the art will recognize, one of the biggest advantages of VLANs is that when a computer is physically moved to another location, it can stay on the same VLAN without hardware reconfiguration. VLANs are defined on a switch on a port-by-port basis. Accordingly, when traffic from multiple VLANs is required to traverse a link that interconnects two network elements, a VLAN tagging method must be configured on the ports that supply the link. Although any suitable tagging method may be configured, in a preferred embodiment, the open standard 802.1q is utilized in the present invention.

In a preferred embodiment, there are two IP Subnet configurations that may be used with the present invention between the upstream, Layer-3 PE IP router 22 and downstream, Layer-3 CE IP router 12. As discussed below, the Subnets have different intended results. The first scheme provides for seamless backwards compatibility. The second scheme primarily provides redundancy among diverse, upstream PE's 22 inside the Service Provider Gateway 20. It is understood, however, that any suitable IP Subnet scheme may be used between the CE 12 and PE 22 depending on the specific application and the desired result.

In a first preferred embodiment, an IP Subnet configuration may consist of a single /30 point-to-point subnet, with only 2 usable IP addresses between the CE 12 and PE 22. In this configuration, it is not permissible to assign an IP address to the inter-working Linecard 36. The advantage of a single /30 point-to-point subnet between the CE 12 and PE 22 is that the service provided over the system is completely transparent to the CE 12. From the CE perspective, the service is the same as the legacy system discussed above (IP/PPP/SONET service) that terminates directly at the PE (IP) router 22. Thus, no change is required to the IP configuration at the CE 12. Of course, a disadvantage of this configuration is that it precludes the Service Provider from assigning an IP address for troubleshooting, specifically during fault isolation of the path from the PE to the CE.

In a second preferred embodiment, the IP subnet configuration may consist of a /29 IP subnet, with 6 usable IP addresses between the CE 12 and the PE 22. The advantage of this configuration is that it allows assignment of an IP address to the system for trouble shooting and further allows two, simultaneous, but separate, eBGP sessions from the same CE 12 to two different upstream PE IP routers 22 Thus, there is seamless 1+1 Layer-3 redundancy of the upstream PE IP routers 22. The disadvantage of this configuration is that it requires coordination from the customer to make even minor IP configuration changes to the CE 12. The configuration also may result in potential asymmetric routing through different PE IP routers 22 to the CE 12, or vice-versa.

As discussed above, since the CE IP router 12 and PE IP router 22 are both unaware that there is a disjoint Layer-2 media (PPP to Ethernet) between them, the inter-working device or functionality must perform ARP mediation. As discussed above, ARP mediation refers to the process of resolving Layer-2 addresses when different resolution protocols are used. With regard to communications from the PE 22 to the CE 12, the inter-working device/functionality 32 will intercept and respond to ARP requests on behalf of the CE 12. In the embodiment of FIG. 3, an ARP response will be sent to the PE containing the inter-working device's own (VLAN-specific) MAC address that must be used to reach the CE's IP address. For communications between the CE and PE, the inter-working device/functionality will originate ARP requests (on behalf of the CE) in order to resolve the correct Layer-2 MAC address of the PE 22 when the CE 12 is attempting to reach a PE 22.

A Media Access Control Address (MAC address) is a unique identifier attached to most forms of networking equipment. Most Layer 2 network protocols use one of three numbering spaces managed by the Institute of Electrical and Electronic Engineers (IEEE), namely, MAC-48, EUI-48, and EUI-64, which are designed to be globally unique. Not all communications protocols, however, use MAC addresses. Similarly, not all protocols which require unique identifiers use MAC addresses. As discussed above, ARP is commonly used to map the Layer-2 MAC address to an address in a Layer-3 protocol such as the Internet Protocol (IP). On broadcast networks such as Ethernet, the MAC address allows each host to be uniquely identified and further allows frames to be marked for specific hosts. The MAC address thus forms the basis of most Layer-2 networking upon which higher OSI Layer protocols are built to produce functioning networks.

Still referring to FIG. 3, the Ethernet interface 38 on the Line Side 36 of inter-working device/functionality 32 is preferably a 10 Gigabit Ethernet (10 GbE), with pluggable optics, e.g. SFP, XENPAK, XFP, X2, etc. More specifically, the interface should support third party XENPAK's, and optionally vendor-supplied XENPAK's. As those skilled in the art are aware, XENPAK is a standard that defines a type of fiber-optic transceiver module which is compatible with the 10 Gigabit Ethernet standard referenced above. XENPAK pluggable optics come in a variety of physical layer interfaces for multi-mode and single fiber optic cables with varying transmission distances.

The interface 38 must also support a suitable VLAN tagging configuration such as, for example, 802.1q encapsulation. In keeping with the invention, it is expected that a single OC-n circuit will map to only a single 802.1q VLAN. A single VLAN, containing traffic from a single OC-n circuit, may span two 10 GbE Gigabit Ethernet ports on the inter-working Linecard 36, in order to provide seamless redundancy to two diverse upstream Layer-3 PE IP routers 22. The inter-working device/functionality 32 will not, however, perform any Layer-3 IP routing for customer traffic that is transiting the device. Instead, it will perform Layer-2 translational bridging of all traffic.

The inter-working device/functionality 32 discussed above is specifically directed to and operable on IP datagrams, which are encapsulated in a limited set of Layer-2 protocols on different sides of the device. More specifically, PPP and Cisco-HDLS must be supported on the Access Side interface 34 toward the SONET/SDH network and Ethernet Type II encapsulation must be supported on the Line Side 36 toward the PE IP routers 22. While PPP and Cisco-HDLS are the most popular WAN protocols presently in use on high-speed SONET/SDH circuits, (OC-3 and above) in current IP networks, any suitable Layer-2 protocol may be used. Thus, it is anticipated that support could be provided, for example, for Frame Relay encapsulation as well as Asynchronous Transfer Mode (ATM) switching. With respect to Layer-3 protocols, it is understood that the device/functionality will support at least IPv4 and IPv6 as well as future enhancements via suitable software upgrades.

The term QoS (Quality of Service) is used in the art to refer to a treatment applied by an IP router/switch to a set of IP packets in order that applications may achieve suitable service (e.g. low delay, low jitter, high bandwidth, etc.) from the network. In a preferred embodiment, the inter-working device/functionality 32 must meet certain requirements which center around number of queues, how to perform classification, marking and scheduling algorithms. With regard to inbound classification, at both the Access and Line side, the inter-working device/functionality 32 supports recognition of the IPv4 DSCP or IPv6 Traffic Class field. By using IP DSCP, it allows for the same classification method to be used on both the Ethernet and SONET/SDH interfaces. This is particularly important in that there is no Layer-2 field upon which to perform classification in PPP or Cisco-HDLC frames.

With regard to outbound queuing, the inter-working device/functionality 32 supports a minimum of two queues per VLAN on the Ethernet Line Side interface 36, and two queues per OC-n circuit on the Access Side SONET/SDH interface 34. The first queue may be used for Control Traffic, e.g. BGP, and the second queue may be used for data traffic. In the case of Frame Relay, both queues may be applied to each virtual single channel interface from the SEID 32 to CE 12. Finally, a maximum buffer size for each queue on each virtual interface is configurable by an operator. In most cases, however, an appropriate default maximum buffer size value for each queue (relevant to each interface speed) will be supplied by the manufacturer and used accordingly. In a preferred embodiment, the inter-working device/functionality 32 of the present invention may also support Deficit Weighted Round-Robin (DWRR) for scheduling packets out of either the Access or Line Side interfaces 34 and 36, respectively.

The device/functionality 32 may also have a default scheduling percentage applied to each of the above referenced queues (e.g. 5% for the Control Queue and 95% for the Data Queue) to avoid unnecessary configurations. Finally, the device/functionality may mark Ethernet 802.1p bits before transmission to an upstream Layer-3 PE as a result of ingress classification previously made on the IP DSCP above. The IP DSCP field should not, however, be re-marked absent an explicit configuration to do so by the operator.

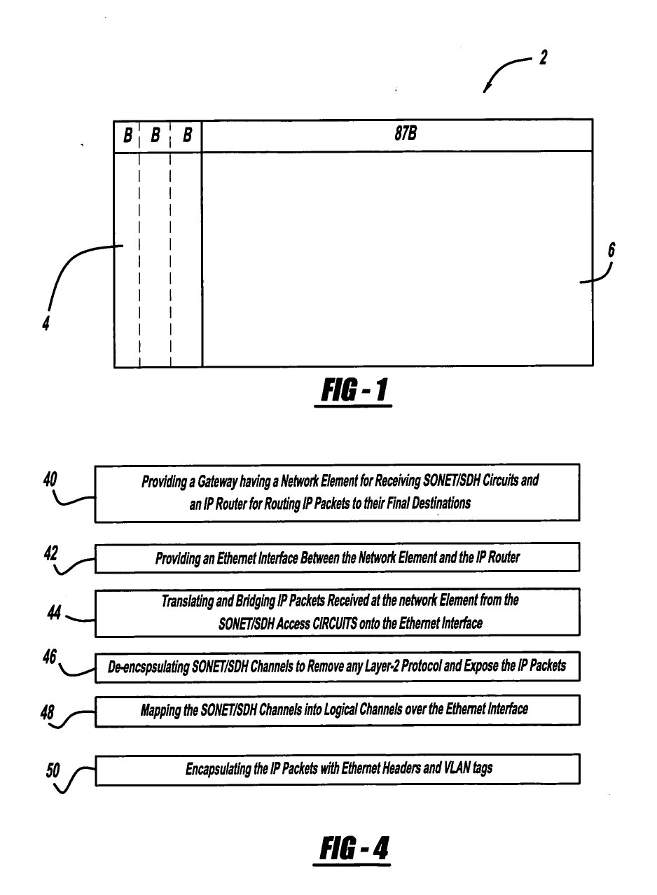

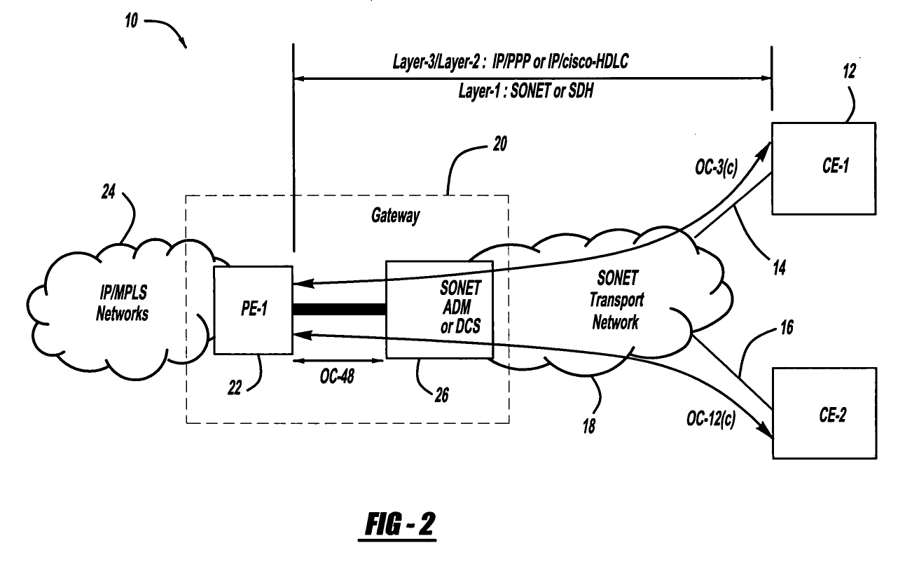

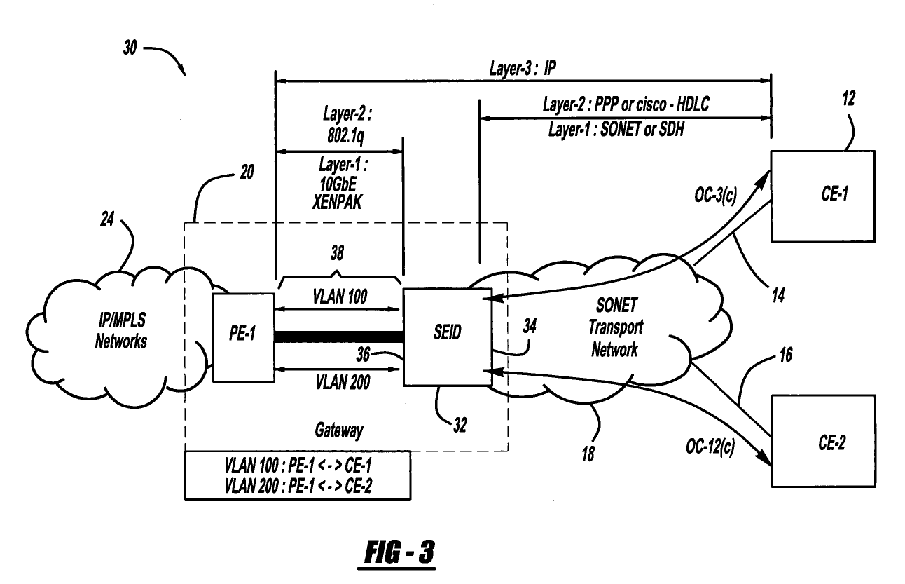

Turning to FIG. 4 of the drawings, there is shown a block diagram of the method of the present invention for terminating SONET/SDH circuits in an IP network to deliver IP packets. The method comprises providing 40 a Gateway having a network element for receiving SONET/SDH circuits and an IP router for routing the IP packets to their final destinations. The method further comprises providing 42 an Ethernet interface between the network element and the IP router. Finally, the method comprises translating and bridging 44 the IP packets received at the network element from the SONET/SDH access circuits onto the Ethernet interface. In a preferred embodiment, the step of translating and bridging the IP packets onto the Ethernet interface further comprises de-encapsulating 46 SONET/SDH channels received at the network element to remove any Layer-2 protocol and expose the IP packets, and mapping 48 the SONET/SDH channels into logical channels over the Ethernet interface. Still further, in the preferred embodiment, the step of mapping the SONET/SDH channels into logical channels further comprises encapsulating 50 the IP packets with Ethernet headers and logical tags such as IEEE 802.1q VLAN tags.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for terminating SONET/SDH circuits in an IP network to deliver IP packets, comprising:
providing a Gateway having a network element for receiving the SONET/SDH circuits and an IP router for routing the IP packets to their final destinations;
providing an Ethernet interface between the network element and the IP router; and
translating and bridging the IP packets received at the network element from the SONET/SDH access circuits onto the Ethernet interface.

2. A method as in claim 1, wherein the step of translating and bridging the IP packets onto the Ethernet interface further comprises:
de-encapsulating SONET/SDH channels received at the network element to remove any Layer-2 protocol and expose the IP packets; and
mapping the SONET/SDH channels into logical channels over the Ethernet interface.

3. A method as in claim 2, wherein the step of mapping the SONET/SDH channels into logical channels further comprises encapsulating the IP packets with Ethernet headers and logical tags.

4. A method as in claim 3, wherein the logical tags are IEEE 802.1q VLAN tags.

5. A method as in claim 1, wherein the network element is a Multi-Service Provisioning Platform (MSPP).

6. A method as in claim 1, wherein the network element is a digital cross connect device.

7. A system for terminating SONET/SDH circuits in an IP network to deliver IP packets, comprising:
a Gateway having a network element for receiving the SONET/SDH circuits and an IP router for routing the IP packets to their final destinations;
an Ethernet interface in communication with the network element and the IP router;
wherein the network element is operative to receive, translate and bridge the SONET/SDH access circuits onto the Ethernet interface.

8. A system as in claim 7, wherein the network element functions to translate and bridge the SONET/SDH access circuits onto the Ethernet interface by (a) de-encapsulating SONET channels received at the network element to remove any Layer-2 protocol and expose the IP packets; (b) map the SONET/SDH channels into logical channels.

9. A system as in claim 8, wherein the network element maps the SONET/SDH channels into logical channels by encapsulating the IP packets with Ethernet headers and logical tags.

10. A system as in claim 9, wherein the logical tags are IEEE 802.1q VLAN tags.

11. A system as in claim 7, wherein the network element is an add/drop multiplexer.

12. A system as in claim 7, wherein the network element is a MSPP.

13. For use in an IP network, a SONET/SDH to Ethernet inter-working device, comprising:
means for receiving SONET/SDH channels;
means for de-encapsulating the SONET/SDH channels to remove any Layer-2 protocol and expose IP packets; and
means for mapping the SONET/SDH channels into logical channels over an Ethernet connection for receipt by an router.

14. An inter-working device as in claim 13, wherein the router is an IP router.

15. An inter-working device as in claim 13, wherein the router is an MPLS router.

16. An inter-working device as in claim 13, wherein the mapping means further comprises means for encapsulating the IP packets with Ethernet headers and logical tags.

17. An inter-working device as in claim 16, wherein the logical tags are IEEE 802.1q VLAN tags.
